(19) United States
(12) Patent Application Publication
(10) Pub. No.: US 2026/0148714 A1
(43) Pub. Date: May 28, 2026

(54) DISPLAY DRIVING SYSTEM AND METHOD THEREOF

(71) Applicant: Iris Optronics Co., Ltd., Tainan City (TW)

(72) Inventors: Ming Liang TSAI, Kaohsiung City (TW); Wu Chang YANG, Tainan City (TW); Chi Chang LIAO, Tainan City (TW)

(21) Appl. No.: 19/401,325

(22) Filed: Nov. 25, 2025

Related U.S. Application Data
(60) Provisional application No. 63/724,912, filed on Nov. 26, 2024.

(51) Int. Cl. G09G 3/36

(52) U.S. Cl. CPC G09G 3/3674; G09G 3/3607; G09G 2320/0233; G09G 2320/0242

(57) ABSTRACT

A display driving system includes a display module, a data source module, a driving parameter storing module and a time sequence controlling module. The display module includes a plurality of pixel unit sets, and the pixel unit sets are divided into a plurality of sub-pixel units. The data source module includes a plurality of data signals, and the data signals correspond to the pixel unit sets. The driving parameter storing module is configured to store a scanning sequence list and a compensating information, the scanning sequence list includes a plurality of sequence information, the sequence information are corresponding to the sub-pixel units, and the compensating information includes a plurality of compensating modes. The time sequence controlling module performs compensation on the data signals to generate a compensating data signal, and drives the display module to display a display screen.

### RELATED APPLICATIONS

This application claims priority to U.S. Provisional Application Ser. No. 63/724,912, filed Nov. 26, 2024, which is herein incorporated by reference.

### BACKGROUND

### Technical Field

The present disclosure relates to a display driving system and a method thereof. More particularly, the present disclosure relates to a display driving system and a method thereof for a Cholesteric Liquid Crystal Display (ChLCD).

### Description of Related Art

ChLCD switches the display screen by applying voltage to the panel to change the state of the liquid crystal. Due to the bistable characteristic, the Frame Per Second (FPS) of ChLCD is lower than the FPS of the general LCD. Hence, the user may have a bad visual experience while switching the display screen.

The conventional ChLCD changes the display sequence by displaying each rows alternately, so as to increase the visual experience of the user. However, the brightness of each of the rows may be brighter than the brightness of a previous row, and the brightness of the display screen displayed by the aforementioned manner may be unevenly. Thus, the display screen with bright and dark staggered may affect the image quality of the display screen.

Therefore, developing a display driving system and a method thereof which can increase the user visual experience without affecting the image quality are commercially desirable.

### SUMMARY

According to one aspect of the present disclosure, a display driving system includes a display module, a data source module, a driving parameter storing module and a time sequence controlling module. The display module includes a plurality of pixel unit sets, and the pixel unit sets are divided into a plurality of sub-pixel units. The data source module includes a plurality of data signals, the data signals correspond to the pixel unit sets. The driving parameter storing module is configured to store a scanning sequence list and a compensating information. The scanning sequence list includes a plurality of sequence information, the sequence information are corresponding to the sub-pixel units, and the compensating information includes a plurality of compensating modes. The time sequence controlling module is signally connected to the display module, the data source module and the driving parameter storing module. The time sequence controlling module accesses the sub-pixel units and the data signals in sequence according to the sequence information of the scanning sequence list, selects at least one of the data signals and performs compensation on the at least one of the data signals according to at least one of the compensating modes to generate at least one compensating data signal, and drives the display module to display a display screen according to the sequence information, the at least one compensating data signal and other data signals without performing compensation.

According to another aspect of the present disclosure, a display driving method includes driving a time sequence controlling module to access a plurality of sub-pixel units and a plurality of data signals in sequence according to a plurality of sequence information of a scanning sequence list, wherein the sequence information are corresponding to the sub-pixel units; driving the time sequence controlling module to select at least one of the data signals and perform compensation on the at least one of the data signals according to at least one of a plurality of compensating modes of a compensating information to generate at least one compensating data signal; and driving the time sequence controlling module to drive a display module to display a display screen according to the sequence information, the at least one compensating data signal and other data signals without performing compensation.

### BRIEF DESCRIPTION OF THE DRAWINGS

The present disclosure can be more fully understood by reading the following detailed description of the embodiment, with reference made to the accompanying drawings as follows:

FIG. 1 shows a block diagram of a display driving system according to a first embodiment of the present disclosure.

FIG. 2 shows a schematic view of a display module of the display driving system of FIG. 1.

FIG. 3 shows a block diagram of a display driving system according to a second embodiment of the present disclosure.

FIG. 4 shows a flow chart of a display driving method according to a third embodiment of the present disclosure.

FIG. 5 shows a flow chart of a display driving method according to a fourth embodiment of the present disclosure.

### DETAILED DESCRIPTION

The embodiment will be described with the drawings. For clarity, some practical details will be described below. However, it should be noted that the present disclosure should not be limited by the practical details, that is, in some embodiment, the practical details is unnecessary. In addition, for simplifying the drawings, some conventional structures and elements will be simply illustrated, and repeated elements may be represented by the same labels.

It will be understood that when an element (or device) is referred to as be “connected to” another element, it can be directly connected to other element, or it can be indirectly connected to the other element, that is, intervening elements may be present. In contrast, when an element is referred to as be “directly connected to” another element, there are no intervening elements present. In addition, the terms first, second, third, etc. are used herein to describe various elements or components, these elements or components should not be limited by these terms. Consequently, a first element or component discussed below could be termed a second element or component.

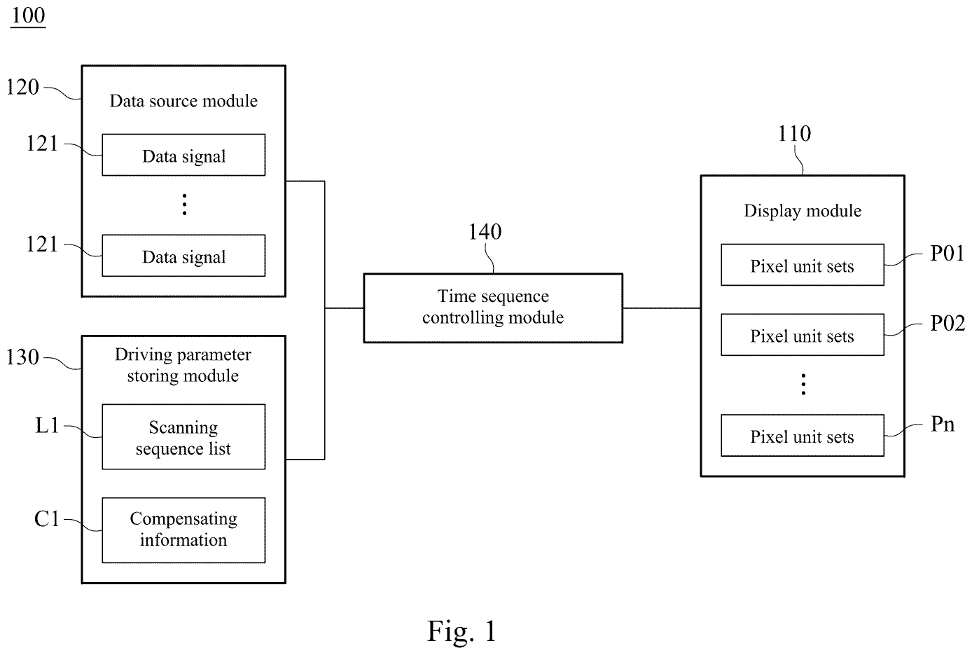

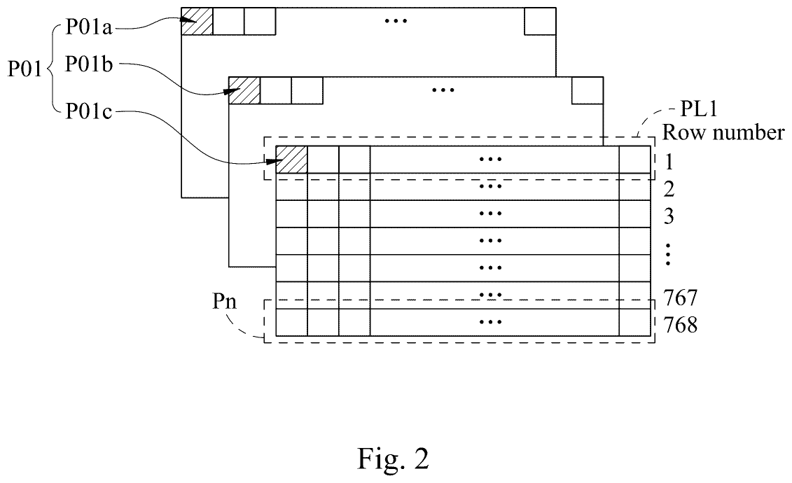

Please refer to FIG. 1 and FIG. 2. FIG. 1 shows a block diagram of a display driving system 100 according to a first embodiment of the present disclosure. FIG. 2 shows a schematic view of a display module 110 of the display driving system 100 of FIG. 1. The display driving system 100 includes a display module 110, a data source module 120, a driving parameter storing module 130 and a time sequence controlling module 140. The display module 110 includes a plurality of pixel unit sets P01, P02, . . . , Pn (P01-Pn), and the pixel unit sets P01-Pn are divided into a plurality of sub-pixel units PL1. The data source module 120 includes a plurality of data signals 121, the data signals 121 correspond to the pixel unit sets P01-Pn. The driving parameter storing module 130 is configured to store a scanning sequence list L1 and a compensating information C1. The scanning sequence list L1 includes a plurality of sequence information, the sequence information are corresponding to the sub-pixel units PL1, and the compensating information C1 includes a plurality of compensating modes. The time sequence controlling module 140 is signally connected to the display module 110, the data source module 120 and the driving parameter storing module 130. The time sequence controlling module 140 accesses the sub-pixel units PL1 and the data signals 121 in sequence according to the sequence information of the scanning sequence list L1, selects at least one of the data signals 121 and performs compensation on the at least one of the data signals 121 according to at least one of the compensating modes to generate at least one compensating data signal, and drives the display module 110 to display a display screen according to the sequence information, the at least one compensating data signal and other data signals 121 without performing compensation.

In detail, the display module 110 can be a ChLCD, the pixel unit sets P01-Pn can be divided into multiple sub-pixel units PL1 by columns or rows. The data source module 120 stores the data signals 121 of every pixel unit sets P01-Pn of the display screen to be displayed on the display module 110, but the present disclosure is not limited thereto.

In FIG. 2, the pixel unit sets P01 can include a first color pixel unit P01a, a second color pixel unit P01b and a third color pixel unit P01c. In other words, each of the pixel unit sets P01-Pn can be stacked by color pixel units with red light, blue light and green light. The sequence information of the scanning sequence list L1 can control the first color pixel unit P01a, the second color pixel unit P01b and the third color pixel unit P01c synchronously, or the sequence information can control the first color pixel unit P01a, the second color pixel unit P01b and the third color pixel unit P01c separately, but the present disclosure is not limited thereto.

Further, the sequence information in the scanning sequence list L1 correspond to the sequence to be displayed on the display module 110 of each of the sub-pixel units PL1. In FIG. 2, the pixel unit sets P01-Pn are divided into multiple sub-pixel units PL1 by rows, but the present disclosure is not limited thereto. Please refer to Table 1, Table 1 lists an embodiment of the sequence information of the scanning sequence list L1 according to the display module 110 in FIG. 2, that is, the display sequence of every rows from top to bottom of the display module 110 in FIG. 2. Moreover, the scanning sequence list L1 is configured to drive the display module 110 to display the data signals 121 of every rows from top to bottom of the display module 110.

TABLE 1

| Sequence | row number of the |
|---|---|
| information | display module 110 |
| 1 | 1 |
| 2 | 2 |
| 3 | 3 |
| 4 | 4 |
| . . . | . . . |
| . . . | . . . |
| 766 | 766 |
| 767 | 767 |
| 768 | 768 |

Please refer to Table 2, Table 2 lists another embodiment of the sequence information of the scanning sequence list L1 according to the display module 110 in FIG. 2, that is, the display sequence of every rows from top to bottom of the display module 110 in FIG. 2. In Table 2, the scanning sequence list L1 is configured to drive the display module 110 to display the data signals 121 of the odd rows (the row number 1, 3, . . . , 767) from top to bottom, then, display the data signals of the even rows (the row number 2, 4, . . . , 766, 768). Thus, the display driving system 100 of the present disclosure can adjust the display sequence of the display module 110 by the scanning sequence list L1, the user can preview the display screen preliminary while switching the display screen, thereby shortening the waiting time.

TABLE 2

| Sequence | row number of the |
|---|---|
| information | display module 110 |
| 1 | 1 |
| 2 | 3 |
| 3 | 5 |
| . . . | . . . |
| 384 | 767 |
| 385 | 2 |
| 386 | 4 |
| . . . | . . . |
| 767 | 766 |
| 768 | 768 |

In other embodiments of the present disclosure, the sequence information of the scanning sequence list L1 also can be displayed by the row number from the bottom to the top in FIG. 2 in sequence, displayed by a multiple of an interval, or displayed in a customized sequence, but the present disclosure is not limited thereto.

The time sequence controlling module 140 drives the display module 110 to display the display screen according to the sequence information of the scanning sequence list L1, and performs compensation on the signal outputted by each of the sub-pixel units PL1 according to the compensating modes, so as to make sure the brightness of every rows (every columns) in the display screen are even. The time sequence controlling module 140 is described in more detail below.

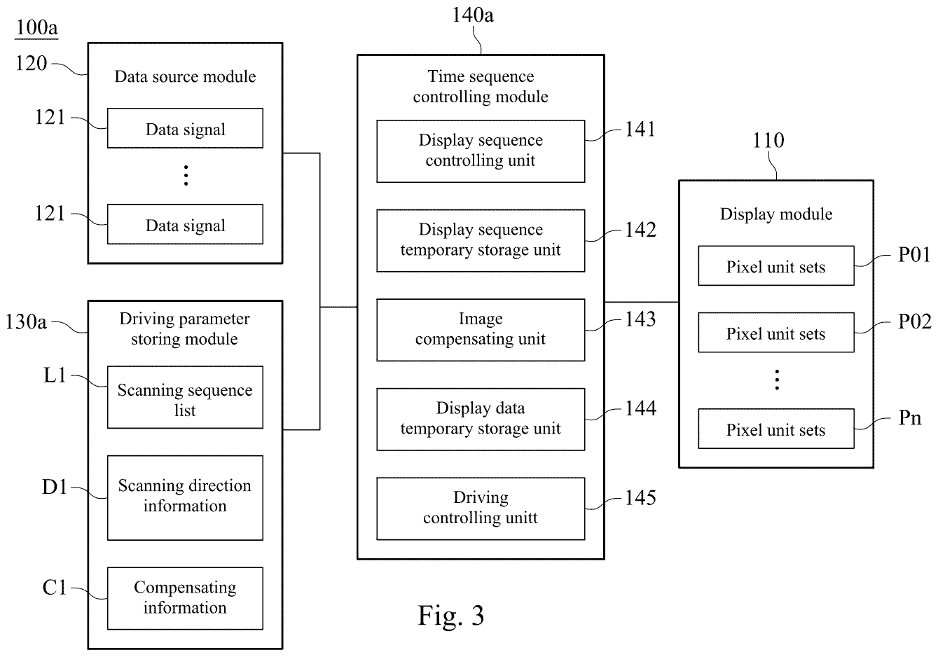

Please refer to FIG. 1 to FIG. 3. FIG. 3 shows a block diagram of a display driving system 100a according to a second embodiment of the present disclosure. The display driving system 100a includes a display module 110, a data source module 120, a driving parameter storing module 130a and a time sequence controlling module 140a. In the second embodiment, the display module 110, the data source module 120 are the same as the display module 110, the data source module 120 of the display driving system 100 in the first embodiment, and will not be described again.

Specifically, the driving parameter storing module 130a can further be configured to store a scanning direction information. The time sequence controlling module 140a can include a display sequence controlling unit 141, a display sequence temporary storage unit 142, an image compensating unit 143, a display data temporary storage unit 144 and a driving controlling unit 145.

In detail, the scanning direction information D1 includes a first direction information, a second direction information and a third direction information, the first direction information, the second direction information and the third direction information can be corresponding to the first color pixel unit P01a, the second color pixel unit P01b and the third color pixel unit P01c, respectively. In other words, the pixel units in blue light, red light and green light can be scanned and displayed in different direction and different sequence information. The sub-pixel units PL1 can be corresponding to multiple rows or multiple columns. When the sub-pixel units PL1 are corresponding to the rows, respectively, the scanning direction information D1 includes from top to bottom or from bottom to top in FIG. 2. When the sub-pixel units PL1 are corresponding to the columns, respectively, the scanning direction information includes from left to right or from right to left in FIG. 2, but the present disclosure is not limited thereto.

The display sequence controlling unit 141 reads the scanning sequence list L1 of the driving parameter storing module 130a. The display sequence temporary storage unit 142 is signally connected to the display sequence controlling unit 141, and accesses the sub-pixel units PL1 and the data signals 121 in sequence according to the sequence information. The image compensating unit 143 selects the at least one of the data signals 121, and preforms compensation on the at least one of the data signals 121 according to the at least one of the compensating modes to generate the at least one compensating data signal. The display data temporary storage unit 144 is signally connected to the image compensating unit, 143 and temporarily stores the at least one compensating data signal. The image compensating unit 143 can perform compensation on the first color pixel units P01a, the second color pixel units P01b and the third color pixel units P01c, respectively.

The driving controlling unit 145 is signally connected to the display sequence temporary storage unit 142 and the display data temporary storage unit 144, and reads the at least one compensating signal corresponding to the sub-pixel units PL1 and the other data signals 121 according to the sequence information to drive the display module 110 to display the display screen. In detail, the driving controlling unit 145 performs compensation on the data signal 121 of the sub-pixel unit PL1, which should be compensated, with the compensating data signal, and outputs the data signal 121 of the sub-pixel unit PL1, which don't need to be compensated, so as to display the display screen.

Moreover, the image compensating unit 143 can be a grayscale compensating unit, and is configured to perform compensation on the grayscale of the sub-pixel units PL1. The compensating modes include a first compensating mode, a second compensating mode, a third compensating mode and a fourth compensating mode. The sub-pixel units PL1 can have a plurality of average grayscale values, respectively. Each of the pixel units in each of the sub-pixel units PL1 has a grayscale value, and an average value of all the grayscale values of all of the aforementioned pixel units is the average grayscale value of each of the sub-pixel units PL1.

The first compensating mode performs compensation on one of the sub-pixel units PL1 according to a difference between a highest one of the average grayscale values and one of the average grayscale values. In other words, the image compensating unit 143 calculates the average grayscale values of all the sub-pixel units PL1, finds out one of the sub-pixel units PL1 with the highest average grayscale value, and performs compensation on the average grayscale values of other sub-pixel units PL1. Therefore, all of the average grayscale values of the other sub-pixel units PL1 become the same as the highest average grayscale value of the sub-pixel unit PL1. For example, the display module 110 includes 768 rows, the sub-pixel unit PL1 with the highest average grayscale value is the 768^{th} row sub-pixel unit PL1, the average grayscale value of the 768^{th} row sub-pixel unit PL1 is 146. The original average grayscale value of the 1^{st} row sub-pixel unit PL1 is 128, that is, a difference between the 1^{st} row sub-pixel unit PL1 and the 768^{th} row sub-pixel unit PL1 is 18. Thus, the image compensating unit 143 performs compensation on the average grayscale value of the 1^{st} row sub-pixel unit PL1 to 146, and so on.

The second compensating mode performs compensation on the one of the sub-pixel units PL1 according to a difference between a lowest one of the average grayscale values and the one of the average grayscale values. In other words, the image compensating unit 143 calculates the average grayscale values of all the sub-pixel units PL1, finds out one of the sub-pixel units PL1 with the lowest average grayscale value, and performs compensation on the average grayscale values of the other sub-pixel units PL1. Therefore, all of the average grayscale values of the other sub-pixel units PL1 become the same as the lowest average grayscale value of the sub-pixel unit PL1. For example, the display module 110 includes 768 rows, the sub-pixel unit PL1 with the lowest average grayscale value is the 1^{st} row sub-pixel unit PL1, the average grayscale value of the 1^{st} row sub-pixel unit PL1 is 128. The original average grayscale value of the 768^{th} row sub-pixel unit PL1 is 146, that is, a difference between the 768^{th} row sub-pixel unit PL1 and the 1^{st} row sub-pixel unit PL1 is 18. Thus, the image compensating unit 143 performs compensation on the average grayscale value of the 768^{th} row sub-pixel unit PL1 to 128, and so on.

The third compensating mode performs compensation on the one of the sub-pixel units PL1 according to a difference between a median of the average grayscale values and the one of the average grayscale values. In other words, the image compensating unit 143 calculates the average grayscale values of all the sub-pixel units PL1, finds out one of the sub-pixel units PL1 with the median average grayscale value, and performs compensation on the average grayscale values of the other sub-pixel units PL1. Therefore, all of the average grayscale values of the other sub-pixel units PL1 become the same as the median average grayscale value of the sub-pixel unit PL1. For example, the display module 110 includes 768 rows, the sub-pixel unit PL1 with the median average grayscale value is the 384^{th} row sub-pixel unit PL1, the average grayscale value of the 384^{th} row sub-pixel unit PL1 is 135. The original average grayscale value of the 768^{th} row sub-pixel unit PL1 is 146, that is, a difference between the 768^{th} row sub-pixel unit PL1 and the 384^{th} row sub-pixel unit PL1 is 11. Thus, the image compensating unit 143 performs compensation on the average grayscale value of the 768^{th} row sub-pixel unit PL1 to 135, and so on.

The fourth compensating mode performs compensation on the one of the sub-pixel units PL1 according to a difference between an average value of the average grayscale values and the one of the average grayscale values. In other words, the image compensating unit 143 calculates the average grayscale values of all the sub-pixel units PL1, finds out an average value of the average grayscale values of all the sub-pixel units PL1, and performs compensation on the average grayscale values of all of the sub-pixel units PL1. Therefore, all of the average grayscale values of the other sub-pixel units PL1 become the same as the average value of all the sub-pixel units PL1. For example, the display module 110 includes 768 rows, the average value of all sub-pixel units PL1 is 138. The original average grayscale value of the 768^{th} row sub-pixel unit PL1 is 146, that is, a difference between the 768^{th} row sub-pixel unit PL1 and the average value of all of the sub-pixel units PL1 is 8. Thus, the image compensating unit 143 performs compensation on the average grayscale value of all of the sub-pixel units PL1 to 138, and so on. Thus, the display driving system 100a of the present disclosure can display the display screen in a louver-type manner, and make sure the brightness of all the sub-pixel units are even.

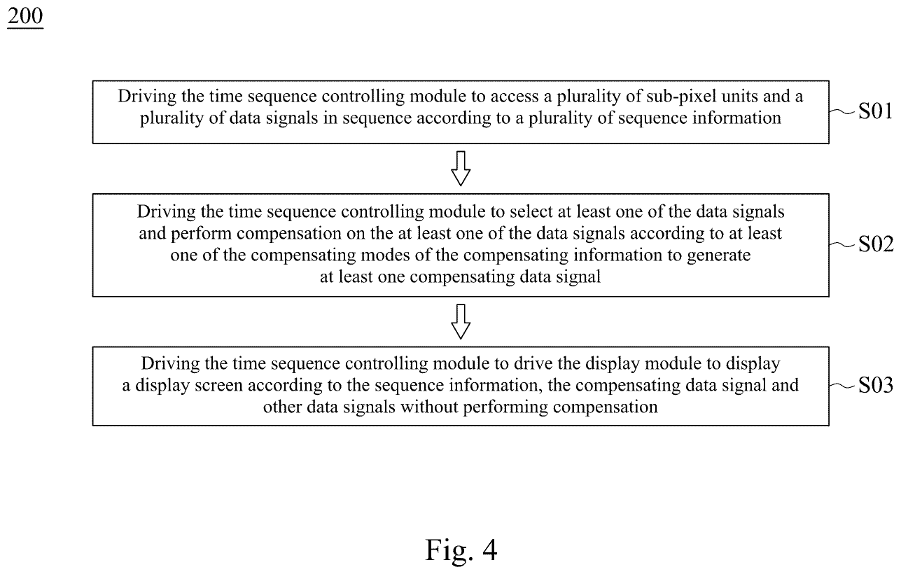

Please refer to FIG. 1, FIG. 2 and FIG. 4. FIG. 4 shows a flow chart of a display driving method 200 according to a third embodiment of the present disclosure. The display driving method 200 includes steps S01, S02, S03. The step S01 includes driving the time sequence controlling module 140 to access a plurality of sub-pixel units PL1 and a plurality of data signals 121 in sequence according to a plurality of sequence information. The sequence information are corresponding to the sub-pixel units PL1. The step S02 includes driving the time sequence controlling module 140 to select at least one of the data signals 121 and perform compensation on the at least one of the data signals 121 according to at least one of a plurality of compensating modes of a compensating information C1 to generate at least one compensating data signal. The step S03 includes driving the time sequence controlling module 140 to drive the display module 110 to display a display screen according to the sequence information, the at least one compensating data signal and other data signals 121 without performing compensation.

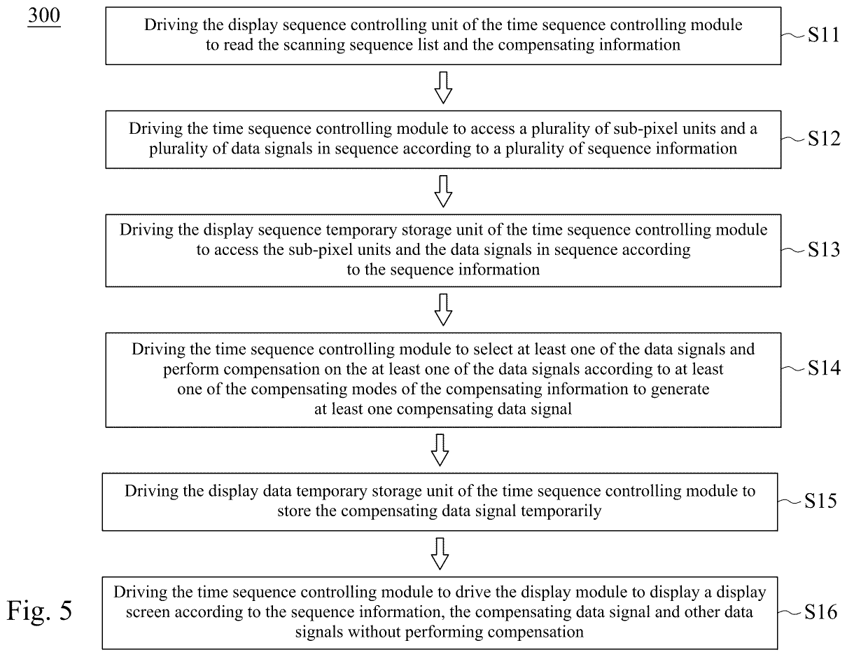

Please refer to FIG. 2 and FIG. 5. FIG. 5 shows a flow chart of a display driving method 200a according to a fourth embodiment of the present disclosure. The display driving method 300 includes steps S11, S12, S13, S14, S15, S16. In the fourth embodiment, the steps S12, S14, S16 are the same as the steps S01, S02, S03 in the display driving method 200 of the third embodiment, respectively, and will not be described again. Moreover, the display driving method 300 can further include the steps S11, S13, S15. The step S11 includes driving the display sequence controlling unit 141 of the time sequence controlling module 140 to read the scanning sequence list L1 and the compensating information C1. The step S13 includes driving the display sequence temporary storage unit 142 of the time sequence controlling module 140 to access the sub-pixel units PL1 and the data signals 121 in sequence according to the sequence information. The step S15 includes driving a display data temporary storage unit 144 of the time sequence controlling module 140 to store the at least one compensating data signal temporarily.

According to the aforementioned embodiments and examples, the advantages of the present disclosure are described as follows.

1. The display driving system of the present disclosure can adjust the display sequence of the display module by the scanning sequence list, the user can preview the display screen preliminary while switching the display screen, thereby shortening the waiting time.

2. The display driving system of the present disclosure can display the display screen in a louver-type manner, and make sure the brightness of all the sub-pixel units are even.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A display driving system, comprising:
a display module comprising a plurality of pixel unit sets, wherein the pixel unit sets are divided into a plurality of sub-pixel units;
a data source module comprising a plurality of data signals, the data signals corresponding to the pixel unit sets;
a driving parameter storing module configured to store a scanning sequence list and a compensating information, wherein the scanning sequence list comprises a plurality of sequence information, the sequence information are corresponding to the sub-pixel units, and the compensating information comprises a plurality of compensating modes; and
a time sequence controlling module signally connected to the display module, the data source module and the driving parameter storing module, wherein the time sequence controlling module accesses the sub-pixel units and the data signals in sequence according to the sequence information of the scanning sequence list, selects at least one of the data signals and performs compensation on the at least one of the data signals according to at least one of the compensating modes to generate at least one compensating data signal, and drives the display module to display a display screen according to the sequence information, the at least one compensating data signal and other data signals without performing compensation.

2. The display driving system of claim 1, wherein the time sequence controlling module comprises:
a display sequence controlling unit reading the scanning sequence list of the driving parameter storing module;
a display sequence temporary storage unit signally connected to the display sequence controlling unit, and accessing the sub-pixel units and the data signals in sequence according to the sequence information;
an image compensating unit selecting the at least one of the data signals, and performing compensation on the at least one of the data signals according to the at least one of the compensating modes to generate the at least one compensating data signal;
a display data temporary storage unit signally connected to the image compensating unit, and temporarily storing the at least one compensating data signal; and
a driving controlling unit signally connected to the display sequence temporary storage unit and the display data temporary storage unit, and reading the at least one compensating signal corresponding to the sub-pixel units and the other data signals according to the sequence information to drive the display module to display the display screen.

3. The display driving system of claim 2, wherein the image compensating unit is a grayscale compensating unit.

4. The display driving system of claim 3, wherein the sub-pixel units have a plurality of average grayscale values, respectively, and the compensating modes comprise:
a first compensating mode performing compensation on one of the sub-pixel units according to a difference between a highest one of the average grayscale values and one of the average grayscale values;
a second compensating mode performing compensation on the one of the sub-pixel units according to a difference between a lowest one of the average grayscale values and the one of the average grayscale values;
a third compensating mode performing compensation on the one of the sub-pixel units according to a difference between a median of the average grayscale values and the one of the average grayscale values; and
a fourth compensating mode performing compensation on the one of the sub-pixel units according to a difference between an average value of the average grayscale values and the one of the average grayscale values.

5. The display driving system of claim 1, wherein the driving parameter storing module is further configured to store a scanning direction information, the time sequence controlling module drives the display module to display the display screen according to the sequence information, the scanning direction information, the at least one compensating data signal and the other data signals without performing compensation.

6. The display driving system of claim 5, wherein the sub-pixel units are corresponding to a plurality of rows or a plurality of columns;
when the sub-pixel units are corresponding to the rows, respectively, the scanning direction information comprises from top to bottom or from bottom to top;
when the sub-pixel units are corresponding to the columns, respectively, the scanning direction information comprises from left to right or from right to left.

7. The display driving system of claim 5, wherein each of the pixel unit sets comprises a first color pixel unit, a second color pixel unit and a third color pixel unit;
wherein the sequence information of the scanning sequence list are corresponding to the first color pixel unit, the second color pixel unit and the third color pixel unit, respectively;
wherein the scanning direction information comprises a first direction information, a second direction information and a third direction information, the first direction information, the second direction information and the third direction information are corresponding to the first color pixel unit, the second color pixel unit and the third color pixel unit, respectively.

8. The display driving system of claim 2, wherein the pixel unit sets comprise a plurality of first color pixel units, a plurality of second color pixel units and a plurality of third color pixel units, and the image compensating unit performs compensation on the first color pixel units, the second color pixel units and the third color pixel units.

9. The display driving system of claim 1, wherein the display module is a Cholesteric Liquid Crystal Display.

10. A display driving method comprising:
driving a time sequence controlling module to access a plurality of sub-pixel units and a plurality of data signals in sequence according to a plurality of sequence information of a scanning sequence list, wherein the sequence information are corresponding to the sub-pixel units;
driving the time sequence controlling module to select at least one of the data signals and perform compensation on the at least one of the data signals according to at least one of a plurality of compensating modes of a compensating information to generate at least one compensating data signal; and
driving the time sequence controlling module to drive a display module to display a display screen according to the sequence information, the at least one compensating data signal and other data signals without performing compensation.

11. The display driving method of claim 10, further comprising:
driving a display sequence controlling unit of the time sequence controlling module to read the scanning sequence list and the compensating information;
driving a display sequence temporary storage unit of the time sequence controlling module to access the sub-pixel units and the data signals in sequence according to the sequence information; and
driving a display data temporary storage unit of the time sequence controlling module to store the at least one compensating data signal temporarily.

12. The display driving method of claim 10, wherein the sub-pixel units have a plurality of average grayscale values, respectively, and the compensating modes comprise:
a first compensating mode performing compensation on one of the sub-pixel units according to a difference between a highest one of the average grayscale values and one of the average grayscale values;
a second compensating mode performing compensation on the one of the sub-pixel units according to a difference between a lowest one of the average grayscale values and the one of the average grayscale values;
a third compensating mode performing compensation on the one of the sub-pixel units according to a difference between a median of the average grayscale values and the one of the average grayscale values; and
a fourth compensating mode performing compensation on the one of the sub-pixel units according to a difference between an average value of the average grayscale values and the one of the average grayscale values.

13. The display driving method of claim 10, further comprising:
driving the time sequence controlling module to drive the display module to display the display screen according to the sequence information, a scanning direction information, the at least one compensating data signal and the other data signals without performing compensation.

14. The display driving method of claim 13, wherein the sub-pixel units are corresponding to a plurality of rows or a plurality of columns;
when the sub-pixel units are corresponding to the rows, respectively, the scanning direction information comprises from top to bottom or from bottom to top;
when the sub-pixel units are corresponding to the columns, respectively, the scanning direction information comprises from left to right or from right to left.

15. The display driving method of claim 13, wherein the sub-pixel units are divided from a plurality of pixel unit sets, each of the pixel unit sets comprises a first color pixel unit, a second color pixel unit and a third color pixel unit;
wherein the sequence information of the scanning sequence list are corresponding to the first color pixel unit, the second color pixel unit and the third color pixel unit, respectively;
wherein the scanning direction information comprises a first direction information, a second direction information and a third direction information, the first direction information, the second direction information and the third direction information are corresponding to the first color pixel unit, the second color pixel unit and the third color pixel unit, respectively.

16. The display driving method of claim 11, wherein the sub-pixel units are divided from a plurality of pixel unit sets, the pixel unit sets comprise a plurality of first color pixel units, a plurality of second color pixel units and a plurality of third color pixel units, and the display driving method further comprises:
driving an image compensating unit to perform compensation on the first color pixel units, the second color pixel units and the third color pixel units, respectively.

17. The display driving method of claim 10, wherein the display module is a Cholesteric Liquid Crystal Display.
